(19) United States
(12) Patent Application Publication
(10) Pub. No.: US 2013/0043989 A1
(43) Pub. Date: Feb. 21, 2013

(54) Method for Supporting the Driver of a Vehicle

(71) Applicant: Volker Niemz, Rutesheim (DE)

(72) Inventor: Volker Niemz, Rutesheim (DE)

(73) Assignee: Robert Bosch GmbH, Stuttgart (DE)

(21) Appl. No.: 13/511,494

(22) PCT Filed: Oct. 6, 2010
(86) PCT No.: PCT/EP2010/064865

§ 371 Date: Oct. 2, 2012

(30) Foreign Application Priority Data
Nov. 23, 2009 (DE) 10 2009 046 966.4

(51) Int. Cl. B62D 6/00; B62D 5/04; B60Q 1/00; G05D 1/00

(52) U.S. Cl. 340/438; 701/25; 701/42

(57) ABSTRACT

A method for supporting the driver of a vehicle by means of electronic steering, in particular during a parking procedure, is disclosed. A roadway to be traversed by the vehicle is first determined and the steering adjustments to the steerable wheels of the vehicle required for traversing the roadway are determined. The roadway is then traversed by means of an automatic control. During traversing of the roadway, an anticipated power requirement is estimated for each of the steering adjustments and the temperature of an actuator by means of which the respective steering adjustments are performed is measured. The automatic control of the vehicle is cancelled and control is transferred to the driver if a specified maximum allowable temperature for the actuator can be exceeded due to the anticipated required power. A device for carrying out the method is also disclosed.

### PRIOR ART

The invention relates to a method for assisting the driver of a vehicle with an electronic steering system, in particular during a parking process. Furthermore, the invention is based on a device for carrying out the method according to the preamble of claim 10.

Methods for assisting the driver of a vehicle are used, in particular, as parking systems in which the driver of the vehicle is assisted during a parking process. In this context, the driver is assisted into a parking space, generally into a longitudinal parking space, during the parking process, either by means of steering instructions or automatic steering wheel control. If the driver is assisted by steering instructions, the driver receives instructions as to how he is to activate the steering wheel via a suitable output device, for example a screen of an on-board computer. In the case of automatic steering wheel control, the steering is generally performed by the system using a suitable actuator drive.

An automatic driver assistance system is described, for example, in US-A 2005/0137769. In said document both the steering and the longitudinal guidance, that is to say accelerations and braking of the vehicle, are performed by the driver assistance system. For this purpose, a control unit, by means of which the wheels are steered in accordance with a steering prescription by the driver at the steering wheel, is provided on the front axle with the steerable wheels. Automatic steering is also possible by virtue of the electrical steering of the front wheels.

However, a disadvantage of driver assistance systems with automatic steering wheel control is that owing to different load sources for the automatic steering additional forces occur which are added to the force which is necessary to control the steerable wheels. The steerable wheels can be controlled, for example, via a steering rack. In this case, the force which has to be applied for the steering is the force which is necessary to move the steering rack. Forces which can occur are, for example, friction forces with the underlying surface, counteracting forces of the tires and wheel suspension and a rebound force owing to torsion. Owing to certain environmental influences, for example the state of the steering and the battery charge state, as well as owing to driving maneuvers with a particular power requirement, for example when steering in a stationary state, the automatic steering system may be switched off or partially activated. This gives rise to a parking process which is interrupted for the driver. The interruption occurs, for example, owing to overheating of the actuator drive for the steering, which overheating occurs, for example, owing to the increased force requirement.

### DISCLOSURE OF THE INVENTION

### Advantages of the Invention

The method according to the invention for assisting the driver of a vehicle with an electronic steering system, in particular during a parking process, comprises the following steps:
(a) determining a path to be traveled along with the vehicle and determining the steering adjustments of the steerable wheels of the vehicle which are necessary to travel along the path and traveling along the path by means of automatic steering,
(b) estimating the expected force requirement for each of the steering adjustments,
(c) measuring the temperature of an actuator drive with which the respective steering adjustment is carried out, and
(d) interrupting the automatic steering of the vehicle and transferring the steering to the driver if a predefined maximum permissible temperature for the actuator drive may be exceeded owing to the expected force requirement.

An advantage of the method according to the invention is that an implausible system interruption is avoided. Prompt communication to the driver occurs before a system abort occurs owing to overheating. In addition, the driver can be informed in good time about the reason for the abort.

If it is necessary to abort the automatic steering of the vehicle, it is advantageous if the transfer of the control to the driver occurs in good time before the aborting of the automatic steering. The transfer of the steering can be indicated to the driver acoustically, visually and/or haptically, for example.

An acoustic indication may occur, for example, by means of a suitable sound signal. A warning sound may be output, for example, as a sound signal. Alternatively it is also possible to request the driver to assume the steering himself now by means of a suitable voice output, for example.

A visual indication may be provided, for example, via a display device of an on-board computer. In this respect it is possible, for example, to allow a request to assume the steering to light up in the display field. Additionally or alternatively to a written message it is also possible for a symbol to be displayed. In order to attract the driver's attention it is also possible for the display of the request to assume the steering to be combined with a change in the color of the display unit. Alternatively or additionally to a change in color, the display could also flash, for example.

In order to indicate the transfer of the steering to the driver haptically it is possible, for example, to generate a vibration in the steering wheel. The vibration gives the driver a clear indication that his attention is requested. However, it is to be expected during an automatic parking process, that is to say a parking process in which the system also assumes the steering, that the driver is not holding the steering wheel and it is, alternatively, also possible for example to communicate the indication to the driver by means of a vibration of the seat or, for example, even by a braking intervention or brief intermittent braking. However, the indication is preferably provided by vibrating the seat and/or the steering wheel.

In addition to the acoustic, visual and/or haptic indication to assume the steering, it is furthermore preferred if the indication of the request to the driver to assume the steering occurs acoustically and visually, acoustically and haptically or visually and haptically. In particular, it is also preferred if the indication occurs acoustically, visually and haptically. In this way it can be ensured that the driver's attention is attracted in all cases.

If the driver receives a request to assume the steering it is preferred if in this case necessary steering movements for traveling along the path determined in step (a) are indicated to the driver when the steering is assumed. This reduces the fully automatic system for assisting the driver to a semi-automatic system. However, the driver continues to receive assistance when parking the vehicle even if the steering of the vehicle and the driving maneuver are now no longer carried out automatically by the vehicle. When the necessary steering movements to travel along the determined path are indicated to the driver it is also advantageous if the reaction time of the driver and the speed with which the driver moves the steering wheel are taken into account in the indication. In this respect it is, for example, possible to provide in the system for the steering speed and the reaction time of the driver to be detected if the system is being operated semi-automatically, that is to say the necessary steering movements are being indicated to the driver. The changed requirements can then be calculated from the data which are detected in this way. The detected data can be stored, for example, in a memory so that this can be accessed again even during later parking processes. In the case of a change of driver it is possible, for example, for another driver to be indicated to the system so that the data which are stored for a driver are not overwritten. However, it is alternatively also possible to determine the data relating to the reaction speed and steering speed anew in each case after the vehicle is restarted. However, it is preferred to store the data for different drivers and to respectively communicate who is driving the vehicle to the system in advance.

In one embodiment of the invention the driver receives, for example before the request to assume the steering, a warning that the steering is being transferred. The warning that the steering is being assumed can occur acoustically, visually and/or haptically. A combination of at least two of the three types of indication is particularly preferred. It is therefore possible, for example, for the warning to occur acoustically and visually, acoustically and haptically, visually and haptically or acoustically, visually and haptically.

In order to avoid the vehicle carrying on driving in an uncontrolled manner at the time when the steering is transferred to the driver since the system has already given up the steering but the driver has not yet assumed the steering, it is advantageous if the vehicle is braked to a stationary state for the transfer of the steering. However, this is possible only if the longitudinal control, that is to say the acceleration and the deceleration of the vehicle, is also performed by the system. In the case of systems in which the driver still performs the acceleration and deceleration it is not possible to brake the vehicle to a stationary state. However, since in systems in which the longitudinal control is with the driver an increased level of attentiveness is required from the driver, the driver will realize in good time that the steering has to be transferred. Only in systems in which the longitudinal control is also performed by the system is it necessary to allow for reduced attentiveness on the part of the driver. This reduced attentiveness on the part of the driver means that if the vehicle is not braked to a stationary state when the steering is transferred the risk of a collision owing to uncontrolled continued travel of the vehicle cannot be ruled out.

In addition to the transfer of the steering to the driver it is furthermore also possible in the case of a fully automatic system to transfer the longitudinal control to the driver. This has the advantage that the driver has complete control of the vehicle and in this way the requirements with respect to the steering lock can also be adapted to the driver's driving style.

In order to be able to estimate the expected force requirement for each of the steering adjustments, for example the speed of the vehicle and the steering speed are taken into account. The force requirement is dependent hereby on the steering speed and on the speed of the vehicle. The slower the vehicle travels and the higher the steering speed, the greater the force requirement for steering. The force requirement if the vehicle is steered in the stationary state is particularly high.

In addition to the steering speed and the speed of the vehicle, the air pressure in the tires of the steerable wheels, the profile depth of the tires of the steerable wheels, the coefficient of friction of the tires on the underlying surface, the temperature and/or the air humidity can additionally be taken into account for estimating the expected force requirement for each of the steering adjustments. For example the expected force requirement for a steering adjustment therefore increases as the air pressure in the tires of the steerable wheels decreases.

The coefficient of friction of the wheels on the underlying surface is also dependent on the air pressure in the tires of the steerable wheels and the profile depth of the tires of the steerable wheels.

The coefficient of friction of the wheels on the underlying surface can be determined, for example, by determining the braking distance. Any other desired way of determining the coefficient of friction of the wheels on the underlying surface which is known to a person skilled in the art can also be used. Determining the coefficient of friction is known to a person skilled in the art from, for example, ESP or ABS systems.

Since the tires usually become softer as the temperature increases, the coefficient of friction also increases as the temperature increases and therefore the necessary force requirement for a steering adjustment increases. An increase in the air humidity generally leads to a reduction in the coefficient of friction and therefore to a decrease in the expected force requirement for each of the steering adjustments.

The coefficient of friction of the wheels on the underlying surface is particularly relevant for the expected force requirement for each steering adjustment, and said coefficient of friction is particularly dependent on the air pressure in the tires of the steerable wheels and the profile depth of the tires of the steerable wheels.

Additional load sources for the actuator drive with which the respective steering adjustments are carried out are also counteracting forces of the tires owing to the steering and the rebound force owing to the torsion.

In the case of a rack-and-pinion steering system, the steering rack with which the steerable wheels are steered is driven with the actuator drive. At the same time, the steering wheel is moved here, with the result that the driver is informed about the respective steering process owing to the rotation of the steering wheel. In an electronic steering system, it is, alternatively, also possible that only the steerable wheels are moved but the steering wheel is decoupled and is therefore not moved. In this case, it is possible, for example, to inform the driver about the current position of the wheels via a display, for example on the display device of the on-board computer. This is important, in particular, if the steering is transferred to the driver.

In order to be able to estimate whether a predefined maximum permissible temperature for the actuator drive may be exceeded owing to the expected force requirement, a resulting temperature increase of the actuator drive is inferred from the estimated expected force requirement. The sum of the temperature increase expected from the force requirement and the measured temperature of the actuator drive yields the critical temperature which is compared with the predefined maximum permissible temperature for the actuator drive. As soon as the predefined maximum permitted temperature for the actuator drive threatens to be exceeded by the temperature which is obtained from the measured temperature of the actuator drive and the temperature which is estimated from the expected force requirement, the corresponding warning is output to the driver and the steering is transferred to the driver. When the steering is transferred to the driver, the steering occurs again independently of the actuator drive, with the result that the actuator drive is not required and can therefore cool down.

As soon as the actuator drive has cooled below a predefined temperature, the steering adjustments can occur automatically again. In this respect it is possible, for example, to indicate to the driver that the steering can now be assumed by the system again. The driver can then be given the option of communicating to the system that he wishes the system to assume the steering. However, it is alternatively also possible for the steering to remain with the driver. The communication that the driver wishes to assume the steering can occur, for example, by activating a switch. The communication that the steering can be performed again by the system can occur, for example, visually via the display device of the on-board computer. However, it is alternatively also possible for the system to automatically assume the steering again and for the driver to merely receive a message that the steering adjustment is taking place again automatically. The message can occur, for example, acoustically, visually or haptically. It is particularly preferred if the message also occurs haptically, for example by adjusting the steering in such a way that a significantly increased force requirement is necessary for activation. However, a simultaneous visual or acoustic indication is preferred here. It is preferred if the driver is given the choice of giving up the steering again to the system or retaining the steering.

The maximum permissible temperature at which the control is transferred to the driver is, for example, the maximum permissible operating temperature at which fault-free functioning of the actuator drive can be ensured. This temperature is equipment-dependent and is predefined, for example, for the actuator drive by the equipment manufacturer. However, it is preferred if the maximum permissible temperature at which the steering is transferred to the driver is below the maximum permissible operating temperature at which the actuator drive can still be operated, in order in this way to obtain a safety margin. The maximum permissible temperature at which the steering is transferred to the driver is therefore preferably at maximum 80% of the maximum permissible operating temperature of the actuator drive.

The predefined temperature at which the steering adjustments occur again automatically after cooling of the actuator motor is, for example, at maximum 60% of the maximum permissible operating temperature of the actuator drive. As a result of the correspondingly large interval of the predefined temperature at which the steering adjustments occur again in an automated fashion it is ensured that transfer to the driver does not occur again after only one steering adjustment but rather that a plurality of steering adjustments can be carried out, wherein it is preferred, in particular, if the number of steering adjustments which can still be carried out is sufficient to terminate the automatic driving process, in particular the parking process.

In order to determine the path to be traveled along with the vehicle, the surroundings of the vehicle are firstly detected. If the driving maneuver to be carried out is a parking process, it is firstly determined whether a sufficiently large parking space which permits parking of the vehicle is present. For this purpose, the surroundings of a longitudinal parking space next to the vehicle are detected as the vehicle drives past. If a space is detected which is long enough to park the vehicle, it is assumed that there is a suitable parking space. With the system for detecting the surroundings it is therefore possible to detect the length of the parking space and, if appropriate, also the width of the parking space. Usually distance sensors which are connected to a suitable evaluation unit are used as a system for detecting the surroundings. Distance sensors which are used are usually, for example, ultrasonic sensors, radar sensors, infrared sensors, capacitive sensors or LIDAR sensors. These sensors output a signal which is reflected by objects in the detection region and said sensors then pick up the echo. The distance from an object can be determined from the propagation time of the signal. The boundaries of a suitable parking space can then be determined from the data detected with the distance system. A parking space is usually bounded by a front boundary, a rear boundary and a lateral boundary. The front and the rear boundaries are generally formed here by further parked vehicles. However, alternatively it also possible that a longitudinal parking space is bounded only by a rear boundary or only by a front boundary. This is the case if the parking space is the first or the last parking space in a row. Such a parking space can be detected, for example, by a recurring pattern of boundaries near to the vehicle, which have approximately the length of a vehicle with short regions aligned between them, in which regions the boundary is further away from the vehicle. Alternatively it is also possible that the driver communicates to the system that the parking space is such a parking space.

A suitable driving-in path is then calculated taking into account the data detected in this way. The driving-in path which is calculated is usually the path which is passed over by the center point of the rear axle of the vehicle. The steering adjustments of the steerable wheels of the vehicle which are necessary to travel along the path are then determined from the path which is determined in this way. In order to park the vehicle in the parking space, the determined path is then traveled along on the basis of the previously determined steering adjustments of the steerable wheels. When the path which is determined in this way is traveled along, the temperature of the actuator drive for the steering adjustments is then respectively measured. If an increased temperature of the actuator drive is measured, in particular a temperature which is already in the vicinity of the predefined maximum permissible temperature or which is already close to the permissible operating temperature of the actuator drive, the expected temperature increase is determined from the expected force requirement for the following steering adjustment. In this way it is possible to estimate whether the predefined maximum permissible temperature for the actuator drive may be exceeded owing to the expected force requirement. If the predefined maximum permissible temperature for the actuator drive may be exceeded, the steering is transferred to the driver.

The invention also relates to a device for carrying out the method, wherein the device comprises a controller, an actuator drive for carrying out steering adjustments and means for detecting the temperature of the actuator drive. The actuator drive can be actuated by the controller and the means for detecting the temperature are connected to the controller, with the result that detected temperatures can be transmitted to the controller. The controller is configured in such a way that it comprises means for detecting a path to be traveled along with the vehicle and for determining the steering adjustments of the steerable wheels of the vehicle which are necessary to travel along the path, as well as means for estimating the force requirement which is necessary for the steering adjustments and for estimating a resulting temperature for the actuator drive.

Any desired actuator drive which is known to a person skilled in the art and with which corresponding steering adjustments can be carried out is suitable for carrying out steering adjustments. The actuator drive is also dependent here, inter alia, on the type of steering system.

For example any desired temperature sensors, for example, thermo-elements, can be used as means for detecting the temperature. Suitable temperature sensors are known to a person skilled in the art. The temperature sensors supply a change in voltage to the controller, wherein the change in voltage can then be converted into a change in temperature and a temperature of the actuator drive.

In order to calculate the path to be traveled along, the controller is preferably equipped with a processor. In addition, a program is to be provided with which the path which is to be traveled along can be calculated. Furthermore, it is advantageous if storage means are provided in which the detected data, for example data of the temperature sensors and of the distance sensors, can be stored. The controller can then access the stored data and calculate the path to be traveled along from the stored data. The force requirement which is necessary to carry out the steering adjustment can be calculated by means of a further program and the expected increase in temperature of the actuator drive can be calculated from the force requirement. Through a comparison with the stored temperature data, the expected temperature can then be determined after the steering adjustment has been carried out, and a warning can be communicated to the driver if it is necessary to abort the automatic steering. For this purpose, the controller is connected, for example, to a suitable display device, for example a monitor, in the dashboard of the vehicle. The exchange of data between the controller and any other desired electronic components can occur, for example, through a suitable bus system, for example a CAN bus.

1. A method for assisting the driver of a vehicle with an electronic steering system, comprising:
(a) determining a path to be traveled along with the vehicle and determining the steering adjustments of the steerable wheels of the vehicle which are necessary to travel along the path and traveling along the path by means of automatic steering,
(b) estimating the expected force requirement for each of the steering adjustments,
(c) measuring the temperature of an actuator drive with which the respective steering adjustments are carried out, and
(d) interrupting the automatic steering of the vehicle and transferring the steering to the driver if a predefined maximum permissible temperature for the actuator drive may be exceeded owing to the expected force requirement.

2. The method as claimed in claim 1, further comprising:
indicating to the driver when the steering is transferred to the driver necessary steering movements for traveling along the path determined in step (a).

3. The method as claimed in claim 1, wherein the driver receives a warning that the steering is being transferred.

4. The method as claimed in claim 1, wherein the transfer of the steering is indicated to the driver acoustically, visually and/or haptically.

5. The method as claimed in claim 1, wherein the vehicle is braked to a stationary state for the transfer of the steering.

6. The method as claimed in claim 1, wherein the steering speed and the speed of the vehicle are taken into account for estimating the expected force requirement for each of the steering adjustments.

7. The method as claimed in claim 6, wherein the air pressure in the tires of the steerable wheels, the profile depth of the tires of the steerable wheels, the coefficient of friction of the wheels on the underlying surface, the temperature and/or the air humidity are additionally taken into account for estimating the expected force requirement for each of the steering adjustments.

8. The method as claimed in claim 1, wherein when the actuator motor cools below a predefined temperature the steering adjustments take place again automatically.

9. The method as claimed in claim 8, wherein the driver receives a message when the steering adjustments take place again automatically.

10. A device for carrying out a method for assisting a driver of a vehicle with an electronic steering system, comprising:
a controller,
an actuator drive configured to carry out steering adjustments, and
means for detecting the temperature of the actuator drive,
wherein the actuator drive is configured to be actuated by the controller and the means for detecting the temperature are connected to the controller so that detected temperatures are transmitted to the controller, and
wherein the controller comprises means for detecting a path to be traveled along with the vehicle and for determining the steering adjustments of the steerable wheels of the vehicle which are necessary to travel along the path, and means for estimating the force requirement which is necessary for the steering adjustment and for estimating a resulting temperature for the actuator drive.
